(19) United States
(12) Patent Application Publication
(10) Pub. No.: US 2021/0110579 A1
(43) Pub. Date: Apr. 15, 2021

(54) SCREENSHOT PROCESSING METHOD AND DEVICE

(71) Applicant: Dingtalk Holding (Cayman) Limited, Grand Cayman (KY)

(72) Inventor: Junyue Cao, Hangzhou (CN)

(73) Assignee: Dingtalk Holding (Cayman) Limited

(21) Appl. No.: 17/127,834

(22) Filed: Dec. 18, 2020

Related U.S. Application Data
(63) Continuation of application No. PCT/CN2019/090850, filed on Jun. 12, 2019.

(30) Foreign Application Priority Data
Jun. 21, 2018 (CN) 201810641744.X

(51) Int. Cl. G06T 11/00; G06F 21/62

(52) U.S. Cl. CPC G06T 11/00; G06K 9/2054; G06F 21/6227; G06F 21/6245

(57) ABSTRACT

A method including acquiring a screenshot image, and hiding private content contained in the screenshot image.

### CROSS REFERENCE TO RELATED APPLICATIONS

This application claims priority to and is a continuation of PCT Patent Application No. PCT/CN2019/090850, filed on 12 Jun. 2019 and entitled “SCREENSHOT PROCESSING METHOD AND DEVICE,” which claims priority to Chinese Patent Application No. 201810641744.X, filed on 21 Jun. 2018 and entitled “SCREENSHOT PROCESSING METHOD AND DEVICE,” which are incorporated herein by reference in their entirety.

### TECHNICAL FIELD

The present disclosure relates to the field of image processing technology, and, more particularly, to screenshot processing methods and devices.

### BACKGROUND

In conventional techniques, users may capture the screen content of electronic devices to form screenshot images. The users may keep the screenshots for viewing in the future or may send the screenshot images to other users to quickly share the screen content. The screenshot function can not only simplify user operations and avoid manual input by the user of relevant content but also show to a certain extent that the relevant content is not fabricated by the user. The screenshot function can also make the shared content more convincing.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

One or more embodiments of the present disclosure provide a screenshot processing method and device.

One or more embodiments of the present disclosure provide a screenshot processing method, comprising:

acquiring a screenshot image; and

hiding private content contained in the screenshot image.

One or more embodiments of the present disclosure provide a screenshot processing device, comprising:

an acquiring unit, for acquiring a screenshot image; and

a processing unit, for hiding private content contained in the screenshot image.

One or more embodiments of the present disclosure provide a screenshot processing method, comprising:

acquiring a screenshot image; and

processing at least a part of the content contained in the screenshot image, so that the at least a part of the content is invisible in the processed screenshot image.

One or more embodiments of the present disclosure provide a screenshot processing method, comprising:

acquiring a screenshot image according to a screenshot operation implemented by a user;

obtaining a screenshot image after hiding processing according to a trigger operation implemented by the user to a button such as one-key hide button corresponding to the screenshot image, wherein at least a part of the content in the screenshot image is subjected to the hiding processing; and

generating a final image according to the screenshot image obtained after the hiding processing.

One or more embodiments of the present disclosure provide a screenshot processing device, comprising:

an acquiring unit, for acquiring a screenshot image; and

a processing unit, for processing at least a part of the content contained in the screenshot image, so that the at least a part of the content is invisible in the processed screenshot image.

One or more embodiments of the present disclosure provide a screenshot processing device, comprising:

an acquiring unit, for acquiring a screenshot image according to a screenshot operation implemented by a user;

an obtaining unit, for obtaining a screenshot image after hiding processing according to a trigger operation implemented by the user to a button such as one-key hide button corresponding to the screenshot image, wherein at least a part of the content in the screenshot image is subjected to the hiding processing; and

a generating unit, for generating a final image according to the screenshot image obtained after the hiding processing.

### BRIEF DESCRIPTION OF DRAWINGS

In order to more clearly explain the technical solutions of the example embodiments of the present disclosure, drawings for the example embodiments of the present disclosure will be briefly described. The drawings are only provided for the purpose of showing the example embodiments and are not to intended to be construed as limitations to the present disclosure. The same reference numerals refer to the same elements throughout the drawings. In the drawings:

FIG. 1 is a schematic diagram of the architecture of a screenshot processing system provided in an example embodiment.

FIG. 2A is a flowchart of a screenshot processing method provided in an example embodiment.

FIG. 2B is a flowchart of an alternative screenshot processing method provided in an example embodiment.

FIG. 2C is a flowchart of an alternative screenshot processing method provided in an example embodiment.

FIG. 3 is a schematic diagram of a communication session interface provided in an example embodiment.

FIG. 4 is a schematic diagram of triggering of a screenshot processing function provided in an example embodiment.

FIG. 5 is a schematic diagram of a screenshot processing interface provided in an example embodiment.

FIG. 6 is a schematic diagram of hiding of key information provided in an example embodiment.

FIG. 7 is a schematic diagram of hiding of alternative key information provided in an example embodiment.

FIG. 8 is a schematic diagram of recovery of a normal display effect provided in an example embodiment.

FIG. 9 is a structural schematic diagram of a device provided in an example embodiment.

FIG. 10 is a block diagram of a screenshot processing device provided in an example embodiment.

FIG. 11 is a structural schematic diagram of a device provided in an example embodiment.

FIG. 12 is a block diagram of a screenshot processing device provided in an example embodiment.

FIG. 13 is a structural schematic diagram of a device provided in an example embodiment.

FIG. 14 is a block diagram of a screenshot processing device provided in an example embodiment.

### DETAILED DESCRIPTION

The example embodiments will be described in detail here and examples thereof are shown in the accompanying drawings. When the following description relates to the accompanying drawings, unless otherwise indicated, the same numbers in different drawings represent the same or similar elements. The manners of implementation described in the following example embodiments do not represent all manners of implementation that are consistent with one or more embodiments of the present disclosure. On the contrary, they are only examples of the devices and methods that are consistent with some aspects of one or more embodiments of the present disclosure as detailed in the appended claims.

It should be noted that in other embodiments, the steps of the corresponding method are not necessarily performed in the order shown and described in the present disclosure. In some other embodiments, the steps included in the method may be more or less than those described in the present disclosure. Further, a single step described in the present disclosure may be split into a plurality of steps for description in other embodiments, and a plurality of steps described in the present disclosure may also be merged into a single step in other embodiments for description.

In an embodiment, a screenshot processing solution of the present disclosure can be applied to electronic devices. For example, the electronic devices may include mobile phones, tablet devices, notebook computers, PDAs (Personal Digital Assistants), wearable devices (e.g., smart glasses and smart watches) and any other types of electronic devices, which are not limited by the present disclosure. During the operation, the electronic device may acquire and process the screenshot image through human-machine interaction with the user.

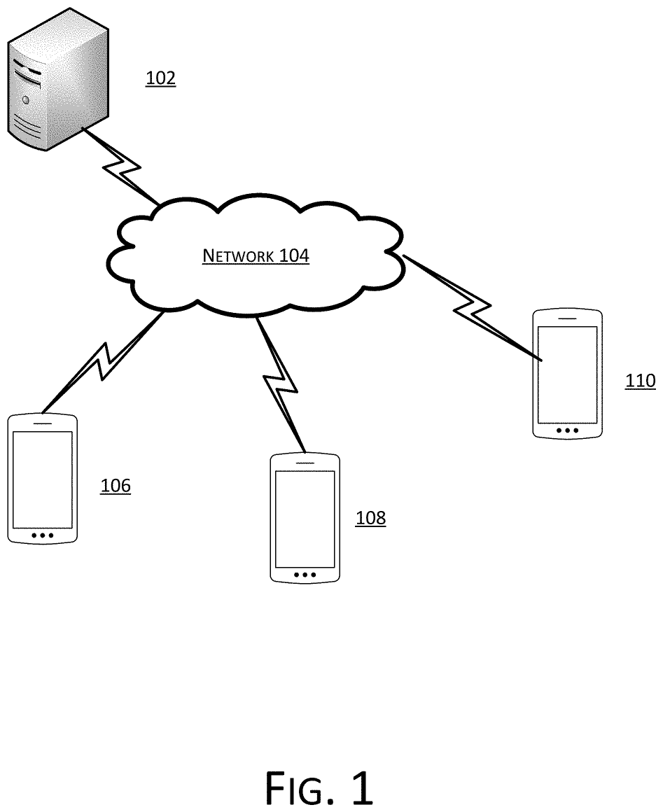

In an embodiment, FIG. 1 is a schematic diagram of the architecture of a screenshot processing system provided in an example embodiment. As shown in FIG. 1, the system may comprise a server 102, a network 104 and a number of electronic devices, such as a mobile phone 106, a mobile phone 108 and a mobile phone 110.

The server 102 may be a physical server containing a stand-alone host, or the server 102 may be a virtual server carried by a host cluster. During the operation, the server 102 may run programs on a server side of an application to become the server side of the application. In a technical solution of one or more embodiments of the present disclosure, the server 102 may work with the clients running on the mobile phones 106 to 110 to process screenshot images.

The mobile phones 106 to 110 are merely one type of electronic device that users can use. In fact, it is obvious that users may also use, for example, the following types of electronic devices: tablet devices, notebook computers, PDAs (Personal Digital Assistants), wearable devices (e.g., smart glasses and smart watches), which are not limited by one or more embodiments of the present disclosure. During operation, the electronic devices may run programs on a client of an application to become to client side of the application. In a technical solution of one or more embodiments of the present disclosure, the clients running on the mobile phones 106 to 110 can achieve human-machine interaction with the users, thereby acquiring screenshot images and working with the server side running on the server 102 to process the screenshot images.

Here, applications of a client on an electronic device can be preinstalled, so that the client can be started and run on the electronic device; certainly, when an online “client” of HTML5 technology is adopted for example, the client can be obtained and run without installing corresponding applications on the electronic device.

The network 104 for interaction between the mobile phones 106 to 110 and the server 102 may include a plurality of types of wired or wireless networks. In an embodiment, the network 104 may include a public switched telephone network (PSTN) and the Internet.

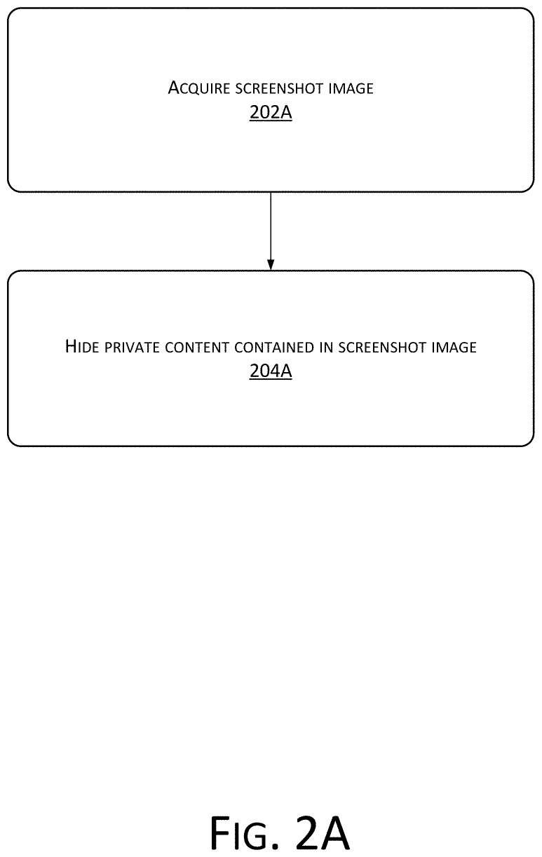

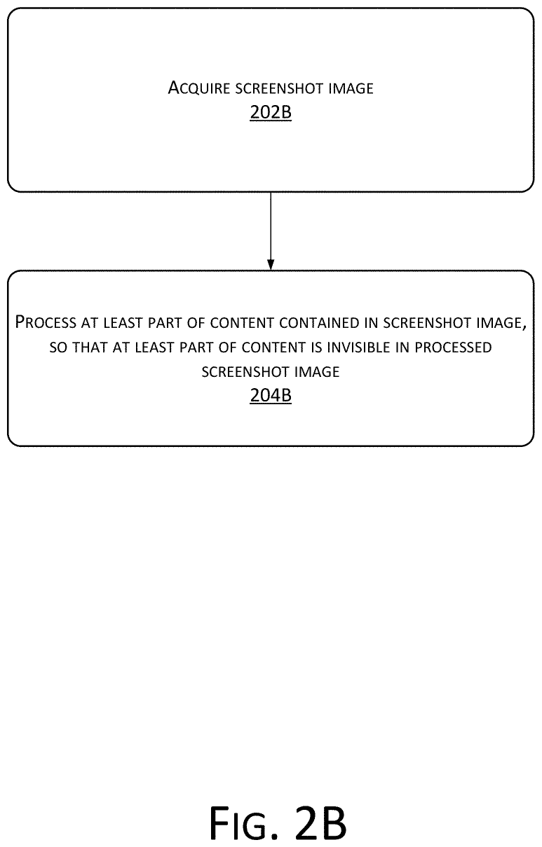

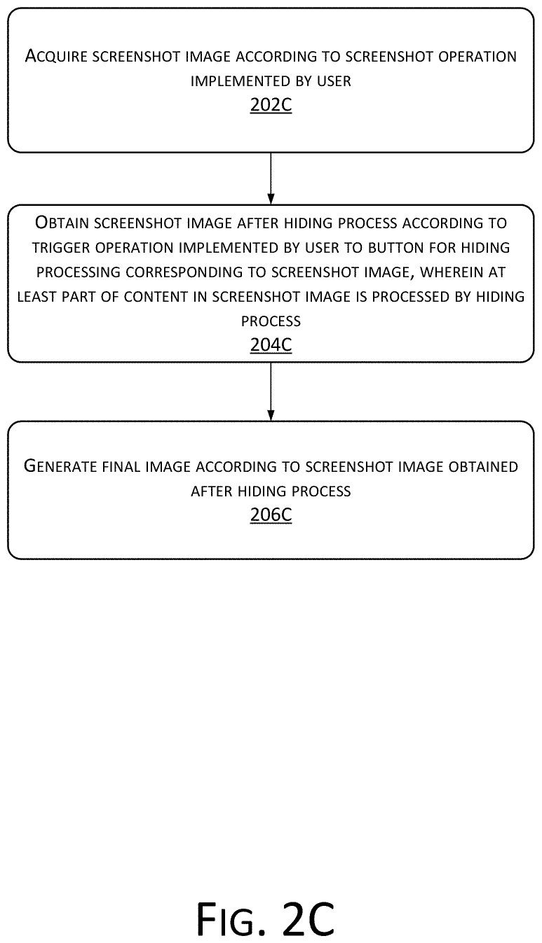

FIG. 2A is a flowchart of a screenshot processing method provided in an example embodiment. As shown in FIG. 2A, the method is applied to electronic devices (e.g., mobile phones 106 to 110 shown in FIG. 1) and may comprise the following steps:

Step 202A, acquiring a screenshot image.

In an embodiment, the electronic device may capture the screen display content of the electronic device to generate a screenshot image when the electronic device detects that a predefined physical key combination is triggered; for example, the physical key combination may comprise “Power key+Volume key”, “Home key+Power key” and “Volume key+Brightness key”, which are not limited by the present disclosure.

In an embodiment, virtual function keys can be shown on the screen of the electronic device. When a trigger operation for the virtual function keys is detected, the screen display content of the electronic device can be captured to generate a screenshot image.

In an embodiment, the electronic device may temporarily generate a screenshot image in the step 202A; or, the electronic device may generate a screenshot image in advance and then read the screenshot image in the step 202A.

Step 204A, hiding private content contained in the screenshot image.

In an embodiment, the private content may be located in a preset fixed area in the screenshot image; in other words, private content can be fixedly displayed in a certain area of the device screen (i.e., the preset fixed area), so hiding processing can be performed directly to the image content in the preset fixed area to ensure completion of the hiding processing of the private content without performing operations of the screenshot image such as content recognition.

In an embodiment, the private content contained in the screenshot image can be recognized and the recognized private content is hidden. In particular, when the area where the private content is located on the device screen is not fixed, the private content can be recognized to ensure completion of the hiding processing of the private content.

In an embodiment, when the private content in the screenshot image is hidden, hiding of the non-private content in the screenshot image should be avoided, as such hiding of non-private content may cause a failure to accurately convey the information that the user needs to express. For example, when private content and non-private content are located in different areas of a screenshot image, it can be ensured that when the preset fixed area where the private content is located is subjected to hiding processing, the preset fixed area does not contain non-private content. For another example, when it is impossible to determine whether private content and non-private content are located in the same area of the screenshot image, or the display positions of the private content and the non-private content are not fixed, the private content and the non-private content can be recognized separately, so that only the private content is hidden to avoid hiding the non-private content. Especially when the private content and the non-private content may cross or overlap with each other, more attention should be paid to distinguishing the private content and the non-private content.

In an embodiment, hiding processing may include blocking the private content. For example, a non-transparent color block is added over the private content, or the display area of the private content is mosaicked.

In an embodiment, hiding processing may include clipping out an image area corresponding to the private content. In particular, when the private content is located in an edge area of the screenshot image, performing the clipping operation on the edge area will not affect the visual integrity of the screenshot image and does not easily expose that the private content is deliberately hidden.

In an embodiment, the electronic device can hide the private content locally.

In an embodiment, the electronic device may upload the screenshot image to a server, so that the server hides the private content and then the electronic device receives a screenshot image, which is returned by the server and completes processing.

In an embodiment, the private content may include at least one of: preset types of information and information containing preset content.

In an embodiment, by setting types of information that may contain private content, i.e., the foregoing preset types, the information containing the preset types may be used as private content in the subsequent process. For example, the preset types may include without limitation user portrait, user name, user position, URL, telephone number and bank card number, may be set according to universal requirements or individualized requirements and are not limited by the present disclosure. The electronic device may display defined information types to a user. The user selects the information types that the user hopes to hide as the foregoing preset types. Here, the user may also add new information types and include them in the foregoing preset types.

In an embodiment, when there is information containing preset content in a screenshot image, the information may be used as private content. The preset content may include text, image, video and other forms, which are not limited by the present disclosure. For example, the preset content may include without limitation a name of a designated user, a portrait of a designated user, a designated URL and a numerical string at a designated length, which is not limited by the present disclosure. The electronic device may display defined content to a user. The user selects the content that the user hopes to hide as the foregoing preset content. The user may also add new content by setting keywords, importing images or via other methods and include the new content in the foregoing preset content

In an embodiment, a client program of an instant messaging application may run on the electronic device, so that the electronic device is configured as a client device of the instant messaging application; and accordingly, by improving the function of the instant messaging application, the client device can implement the screenshot processing solution of the present disclosure. Therefore, after a screenshot operation is implemented for the application interface of the instant messaging application to obtain a screenshot image, an option for enabling a private content hiding function provided by the instant messaging application can be shown regarding the screenshot image (i.e., through the foregoing functional improvement, the private content hiding function is obtained) and when the enabling option is triggered, the private content contained in the screenshot image is hidden.

In an embodiment, the private content hiding function can be a system-level functional improvement provided by the operating system of the electronic device. The private content hiding function can be built into the operating system or can be obtained through system upgrading later. Accordingly, a screenshot operation can be performed for the screen display content of a device on the local side (a screenshot can be taken on any interface at any time, which is not limited to the application interface of a certain application) to obtain the screenshot image; then an option for enabling a private content hiding function provided by the operating system of the device on the local side can be shown regarding the screenshot image and when the enabling option is triggered, the private content contained in the screenshot image is hidden.

In an embodiment, normal display of at least one piece of private content can be recovered in response to a recovery operation of the at least one piece of private content hidden during the hiding processing. For example, when the user hopes to display the designated private content normally, or the user believes that the designated private content is actually non-private content, the user may cause the designated private content to recover normal display based on the foregoing recovery operation.

In an embodiment, the electronic device may share processed screenshot images, for example send the processed screenshot images to one or more users, or send the processed screenshot images to one or more groups, or share the processed screenshot images to social network platforms, and so on and so forth, which are not limited by the present disclosure. In another embodiment, the electronic device may store screenshot images in a local or cloud storage space without directly sharing the screenshot images.

FIG. 2B is a flowchart of an alternative screenshot processing method provided in an example embodiment. As shown in FIG. 2B, the method is applied to electronic devices (e.g., mobile phones 106 to 110 shown in FIG. 1) and may comprise the following steps:

Step 202B, acquiring a screenshot image.

In an embodiment, the electronic device can capture the screen display content of the electronic device to generate a screenshot image when the electronic device detects that a predefined physical key combination is triggered; for example, the physical key combination may comprise “Power key+Volume key”, “Home key+Power key” and “Volume key+Brightness key”, which are not limited by the present disclosure.

In an embodiment, virtual function keys can be shown on the screen of the electronic device. When a trigger operation for the virtual function keys is detected, the screen display content of the electronic device can be captured to generate a screenshot image.

In an embodiment, the electronic device may temporarily generate a screenshot image in the step 202B; or, the electronic device may generate a screenshot image in advance and then read the screenshot image in the step 202B.

Step 204B, processing at least a part of the content contained in the screenshot image, so that at least the part of the content is invisible in the processed screenshot image.

In an embodiment, at least a part of the content may include any content in the screenshot image, which is not limited by the present disclosure.

In an embodiment, at least a part of the content may include preset content; in another embodiment, at least a part of the content may include content designated by the user.

In an embodiment, at least a part of the content may include private content, key content, sensitive content, irrelevant content, etc.

In an embodiment, at least a part of the content may be located in a preset fixed area in the screenshot image; in other words, at least a part of the content can be fixedly displayed in a certain area of the device screen (i.e., the preset fixed area), so the image content in the preset fixed area can be processed directly to ensure completion of processing of at least a part of the content without performing operations of the screenshot image such as content recognition.

In an embodiment, information contained in the screenshot image can be recognized, and at least a part of the content may contain preset types of information; and for example, the preset types may include private type, sensitive type, URL type, portrait type, position type, etc., which are not limited by the present disclosure. When the area where the preset types of information are located on the device screen is not fixed, the information can be recognized to ensure completion of processing of at least a part of the content.

In an embodiment, at least a part of the content may be very important. For example, at least a part of the content is private content and by making at least a part of the content invisible in the processed screenshot image and only keeping the remaining content of the screenshot image, leakage of at least a part of the content can be avoided.

In an embodiment, at least a part of the content may not be important. By making at least a part of the content invisible in the processed screenshot image and only keeping the remaining content of the screenshot image, interference by at least a part of the content with the remaining content of the screenshot image can be avoided to help improve user information acquisition efficiency.

In an embodiment, when at least a part of the content in a screenshot image is processed, processing of the remaining content in the screenshot image should be avoided, as such processing of the remaining content may cause a failure to accurately convey the information that the user needs to express. For example, when at least a part of the content and the remaining content are located in different areas of a screenshot image, it can be ensured that when the preset fixed area where at least a part of the content is located is processed, the preset fixed area does not contain the remaining content. For another example, when it is impossible to determine whether at least a part of the content and the remaining content are located in the same area of the screenshot image, or the display positions of at least a part of the content and the remaining content are not fixed, at least a part of the content and the remaining content can be recognized separately, so that only at least a part of the content is processed to avoid processing the content in the area. Especially when at least a part of the content and the remaining content may cross or overlap one another, more attention should be paid to distinguishing at least a part of the content and the remaining content.

In an embodiment, the processing of at least a part of the content may include hiding processing, or other processing methods that can make at least a part of the content invisible, which are not limited by the present disclosure.

In an embodiment, the processing may include blocking the at least a part of the content. For example, a non-transparent color block is added over the at least a part of the content, or the display area of the at least a part of the content is mosaicked.

In an embodiment, the processing may include clipping out the image area corresponding to the at least a part of the content. In particular, when the at least a part of the content is located in an edge area of the screenshot image, performing the clipping operation on the edge area will not affect the visual integrity of the screenshot image and does not easily expose that the at least a part of the content is deliberately hidden.

In an embodiment, the electronic device may process the at least a part of the content locally.

In an embodiment, the electronic device may upload the screenshot image to a server, so that the server processes the at least a part of the content and then the electronic device receives the screenshot image, which is returned by the server and completes processing.

In an embodiment, the at least a part of the content may include at least one of: preset types of information and information containing preset content.

Private information is taken as an example. By setting types of information that may contain private content, i.e., the foregoing preset types, the information containing the preset types may be used as private content in the subsequent process. For example, the preset types may include without limitation user portrait, user name, user position, URL, telephone number and bank card number, may be set according to universal requirements or individualized requirements and are not limited by the present disclosure. The electronic device may display defined information types to a user. The user selects the information types that the user hopes to hide as the foregoing preset types. The user may also add new information types and include them in the foregoing preset types.

Private information is again taken as an example. When there is information containing preset content in a screenshot image, the information may be used as private content. The preset content may include text, image, video and other forms, which are not limited by the present disclosure. For example, the preset content may include without limitation a name of a designated user, a portrait of a designated user, a designated URL and a numerical string of a designated length, which are not limited by the present disclosure. The electronic device may display defined content to a user. The user selects the content that the user hopes to hide as the foregoing preset content. The user may also add new content by setting keywords, importing images or via other methods and include the new content into the foregoing preset content

In an embodiment, a client program of an instant messaging application may run on the electronic device, so that the electronic device is configured as a client device of the instant messaging application; and accordingly, by improving the function of the instant messaging application, the client device can implement the screenshot processing solution of the present disclosure. Therefore, after a screenshot operation is implemented for the application interface of the instant messaging application to obtain the screenshot image, an option for enabling a content processing function provided by the instant messaging application can be shown regarding the screenshot image (i.e., through the foregoing functional improvement, the content processing function is obtained) and when the enabling option is triggered, at least a part of the content contained in the screenshot image is processed.

In an embodiment, the content processing function may be a system-level functional improvement provided by the operating system of the electronic device. The content processing function may be built into the operating system or may be obtained through system upgrading later. Accordingly, a screenshot operation can be performed for the screen display content of a device on the local side (a screenshot can be taken on any interface at any time, which is not limited to the application interface of a certain application) to obtain the screenshot image; then an option for enabling a content processing function provided by the operating system of the device on the local side can be shown regarding the screenshot image and when the enabling option is triggered, the at least a part of the content contained in the screenshot image is processed.

In an embodiment, normal display of at least a part of invisible content (i.e., the foregoing at least a part of content) can be recovered in response to a recovery operation of the invisible content. Taking at least a part of the content as private content as an example, when the user hopes to display the designated private content normally, or the user believes that the designated private content is actually non-private content, the user may cause the designated private content to recover normal display based on the foregoing recovery operation.

In an embodiment, the electronic device may share processed screenshot images, for example send the processed screenshot images to one or more users, or send the processed screenshot images to one or more groups, or share the processed screenshot images on social networking platforms, and so on and so forth, which are not limited by the present disclosure. In another embodiment, an electronic device may store the processed screenshot images in a local or cloud storage space without directly sharing the screenshot images.

FIG. 2C is a flowchart of an alternative screenshot processing method provided in an example embodiment. As shown in FIG. 2C, the method is applied to electronic devices (e.g., mobile phones 106 to 110 shown in FIG. 1) and may comprise the following steps:

Step 202C, acquiring a screenshot image according to a screenshot operation implemented by a user.

In an embodiment, the electronic device may capture the screen display content of the electronic device to generate a screenshot image when the electronic device detects that a predefined physical key combination is triggered; for example, the physical key combination may comprise “Power key+Volume key”, “Home key+Power key” and “Volume key+Brightness key”, which are not limited by the present disclosure.

In an embodiment, virtual function keys can be shown on the screen of the electronic device. When a trigger operation for the virtual function keys is detected, the screen display content of the electronic device can be captured to generate a screenshot image.

Step 204C, obtaining a screenshot image after hiding processing according to a trigger operation implemented by the user to a button for hiding processing corresponding to the screenshot image, wherein at least a part of the content in the screenshot image is processed by the hiding processing.

In an embodiment, at least a part of the content may include any content in the screenshot image, which is not limited by the present disclosure.

In an embodiment, at least a part of the content may include preset content; in another embodiment, at least a part of the content may include content designated by the user.

In an embodiment, at least a part of the content may include private content, key content, sensitive content, irrelevant content, etc.

In an embodiment, at least a part of the content may be located in a preset fixed area in the screenshot image; in other words, at least a part of the content can be fixedly displayed in a certain area of the device screen (i.e., the preset fixed area), so hiding processing can be performed directly to the image content in the preset fixed area to ensure completion of hiding processing of at least a part of the content without performing operations of the screenshot image such as content recognition.

In an embodiment, information contained in the screenshot image can be recognized, and at least a part of the content may contain preset types of information; and for example, the preset types may include private type, sensitive type, URL type, portrait type, position type, etc., which are not limited by the present disclosure. When the area where the preset types of information are located on the device screen is not fixed, the information can be recognized to ensure completion of hiding processing of at least a part of the content.

In an embodiment, at least a part of the content may be very important. For example, at least a part of the content is private content and by making at least a part of the content invisible in the screenshot image and only keeping the remaining content of the screenshot image after hiding processing, leakage of at least a part of the content can be avoided.

In an embodiment, at least a part of the content may not be important. By making at least a part of the content invisible in the screenshot image and only keeping the remaining content of the screenshot image after hiding processing, interference by at least a part of the content with the remaining content of the screenshot image can be avoided to help improve user information acquisition efficiency.

In an embodiment, when at least a part of the content in a screenshot image is hidden, hiding of the remaining content in the screenshot image should be avoided, as such hiding of the remaining content may cause a failure to accurately convey the information that the user needs to express. For example, when at least a part of the content and the remaining content are located in different areas of a screenshot image, it can be ensured that when the preset fixed area where at least a part of the content is located is subjected to hiding processing, the preset fixed area does not contain the remaining content. For another example, when it is impossible to determine whether at least a part of the content and the remaining content are located in the same area of the screenshot image, or the display positions of at least a part of the content and the remaining content are not fixed, at least a part of the content and the remaining content can be recognized separately, so that only at least a part of the content is hidden to avoid hiding the content in the area. Especially when at least a part of the content and the remaining content may cross or overlap one another, more attention should be paid to distinguishing at least a part of the content and the remaining content.

In an embodiment, the hiding processing may include blocking the at least a part of the content. For example, a non-transparent color block is added over the at least a part of the content, or the display area of the at least a part of the content is mosaicked.

In an embodiment, the hiding processing may include clipping out the image area corresponding to the at least a part of the content. In particular, when the at least a part of the content is located in an edge area of the screenshot image, performing the clipping operation on the edge area will not affect the visual integrity of the screenshot image and does not easily expose that the private content is deliberately hidden.

In an embodiment, the electronic device may hide the at least a part of the content locally.

In an embodiment, the electronic device may upload the screenshot image to a server, so that the server hides the at least a part of the content and then the electronic device receives a screenshot image, which is returned by the server and completes hiding processing.

In an embodiment, the at least a part of the content may include at least one of: preset types of information and information containing preset content.

Private information is taken as an example. By setting types of information that may contain private content, i.e., the foregoing preset types, the information containing the preset types may be used as private content in the subsequent process. For example, the preset types may include without limitation user portrait, user name, user position, URL, telephone number and bank card number, may be set according to universal requirements or individualized requirements and are not limited by the present disclosure. The electronic device may display defined information types to a user. The user selects the information types that the user hopes to hide as the foregoing preset types. The user may also add new information types and include them in the foregoing preset types.

Private information is again taken as an example. When there is information containing preset content in a screenshot image, the information may be used as private content. The preset content may include text, image, video and other forms, which are not limited by the present disclosure. For example, the preset content may include without limitation a name of a designated user, a portrait of a designated user, a designated URL and a numerical string in a designated length, which are not limited by the present disclosure. The electronic device may display defined content to a user. The user selects the content that the user hopes to hide as the foregoing preset content. The user may also add new content by setting keywords, importing images or other methods and include the new content in the foregoing preset content.

In an embodiment, a client program of an instant messaging application may run on the electronic device, so that the electronic device is configured as a client device of the instant messaging application; accordingly, by improving the function of the instant messaging application, the client device can implement the screenshot processing solution of the present disclosure. Therefore, after a screenshot operation is implemented for the application interface of the instant messaging application to obtain the screenshot image, an option for enabling (e.g., one-key hide button) a content hiding function provided by the instant messaging application can be shown regarding the screenshot image (i.e., through the foregoing functional improvement, the content hiding function is obtained) and when the enabling option is triggered, at least a part of the content contained in the screenshot image is hidden.

In an embodiment, the content hiding function can be a system-level functional improvement provided by the operating system of the electronic device. The content hiding function can be built into the operating system or can be obtained through system upgrading later. Accordingly, a screenshot operation can be performed for the screen display content of a device on the local side (a screenshot can be taken on any interface at any time, which is not limited to the application interface of a certain application) to obtain the screenshot image; then an option (e.g., one-key hide button) for enabling a private content hiding function provided by the operating system of the device on the local side can be shown regarding the screenshot image and when the enabling option is triggered, the at least a part of the content contained in the screenshot image is hidden.

In an embodiment, normal display of at least a part of invisible content (i.e., the foregoing at least a part of content) can be recovered in response to a recovery operation of the invisible content. Taking at least a part of the content as private content as an example, when the user hopes to display the designated private content normally, or the user believes that the designated private content is actually non-private content, the user may cause the designated private content to recover normal display based on the foregoing recovery operation.

In an embodiment, the electronic device may share screenshot images after hiding processing, for example send the screenshot images to one or more users, or send the screenshot images to one or more groups, or share the screenshot images to social network platforms, and so on and so forth, which are not limited by the present disclosure. In another embodiment, an electronic device may store the screenshot images after hiding processing in a local or cloud storage space without directly sharing the screenshot images.

Step 206C, generating a final image according to the screenshot image obtained after the hiding processing.

In an embodiment, the hidden screenshot images may be used as the final images.

In an embodiment, the final images are generated according to an editing operation implemented by the user on the hidden screenshot images. For example, the editing operation may perform any editing processing on the screenshot image after hiding processing, such as adding text, drawing a pattern, rotating an angle and adjusting a zoom ratio, which is not limited by the present disclosure.

For easy understanding, an instant messaging application, “Instant messaging application,” is taken as an example to describe the technical solutions of one or more embodiments of the present disclosure. It is assumed that an Instant messaging application client runs on a mobile phone 106 and an Instant messaging application server runs on a server 102; when Instant messaging application provides a screenshot processing solution in the present disclosure, the user on the local side operates the Instant messaging application client on the mobile phone 106 and hides the private content in the screenshot image.

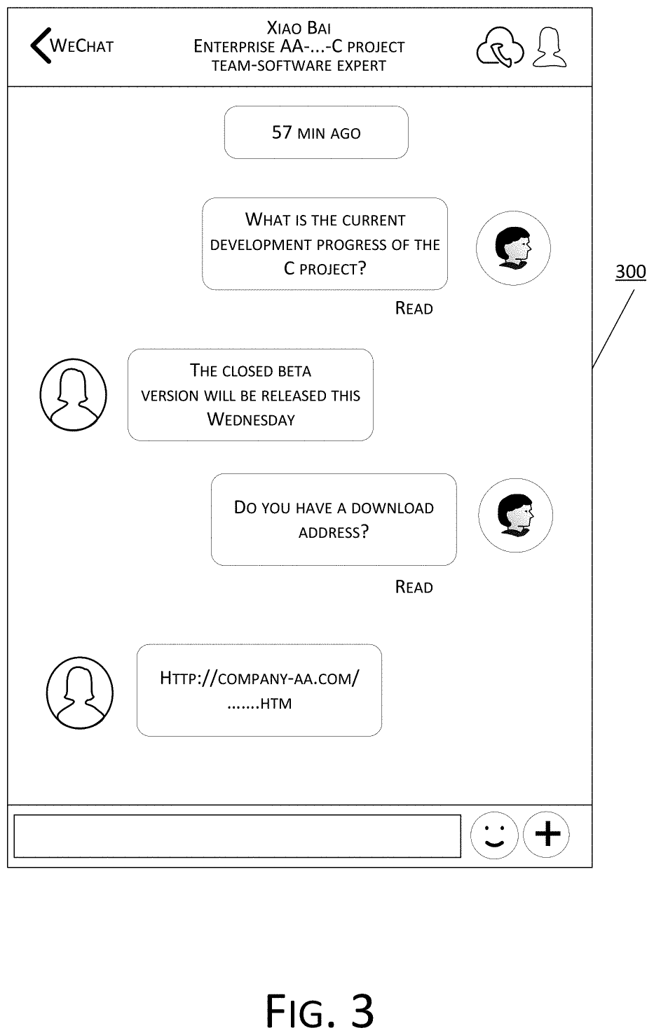

FIG. 3 is a schematic diagram of a communication session interface provided in an example embodiment. The Instant messaging application client running on the mobile phone 106 can present a communication session interface 300 as shown in FIG. 3 to the user, so that the user on the local side can communicate with the user on the opposite side, “Xiao Bai.” For example, in the communication session interface 300 shown in FIG. 3, the right side shows the portrait of the user on the local side and communication messages that the user on the local side has sent, and the left side shows the portrait of the user on the opposite side, “Xiao Bai,” and communication messages that the user on the opposite side has sent (i.e., that the local user has received). At the top of the communication session interface 300, there may also be information about the user on the opposite side, “Xiao Bai.” For example, the user name is “Xiao Bai,” the position is “Enterprise AA- . . . -C project team-software expert,” etc.

When a user on the local side wants to capture screen display content corresponding to the communication session interface 300, the user on the local side may implement a screenshot operation by any screenshot method in the conventional techniques, which is not limited by the present disclosure. For example, the user on the local side may trigger a screenshot function of an electronic device by pressing a plurality of designated physical keys on a mobile phone 106 at the same time, such as “Power key+Home key,” to implement a screenshot operation and generate a screenshot image.

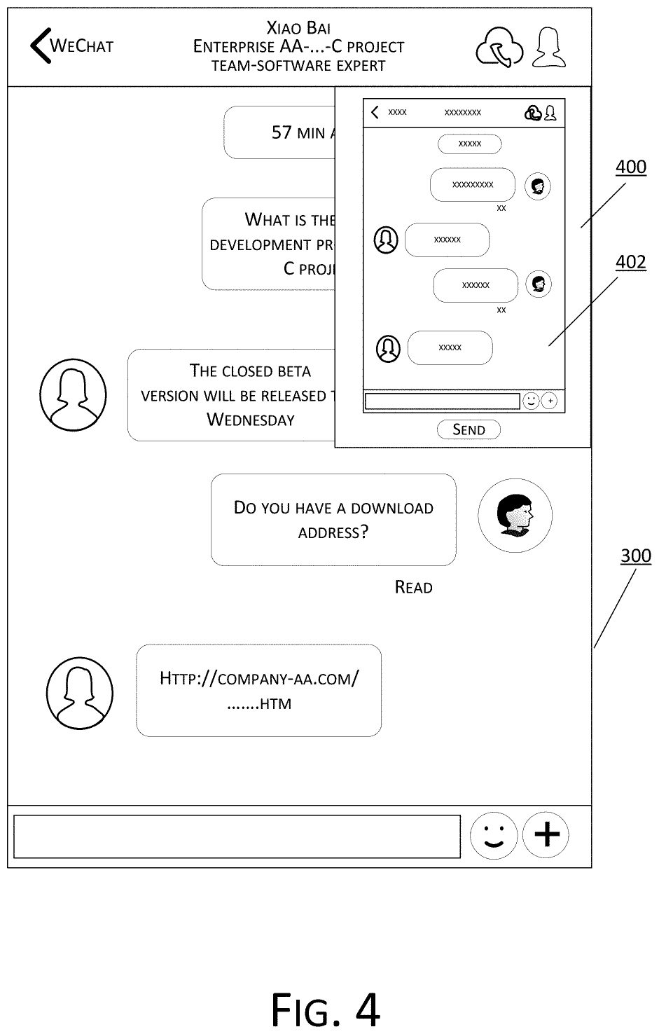

In an embodiment, when an instant messaging applicant such as an Instant messaging application client is in the foreground of an electronic device and detects that the foregoing screenshot operation is triggered, it means that the user on the local side has implemented a screenshot operation for an application interface in the Instant messaging application client, so the Instant messaging application client can trigger a corresponding screenshot processing function to implement a screenshot processing solution in the present disclosure. For example, FIG. 4 is a schematic diagram of triggering of a screenshot processing function provided in an example embodiment. As shown in FIG. 4, the Instant messaging application client can form a display window 400 on the device screen and a thumbnail 402 of the foregoing screenshot image is shown in the display window 400 for the view of the user on the local side. When the user on the local side accepts the content contained in the thumbnail 402, the user on the local side may trigger the foregoing screenshot processing function by triggering a “Send” option to process the screenshot image corresponding to the thumbnail 402.

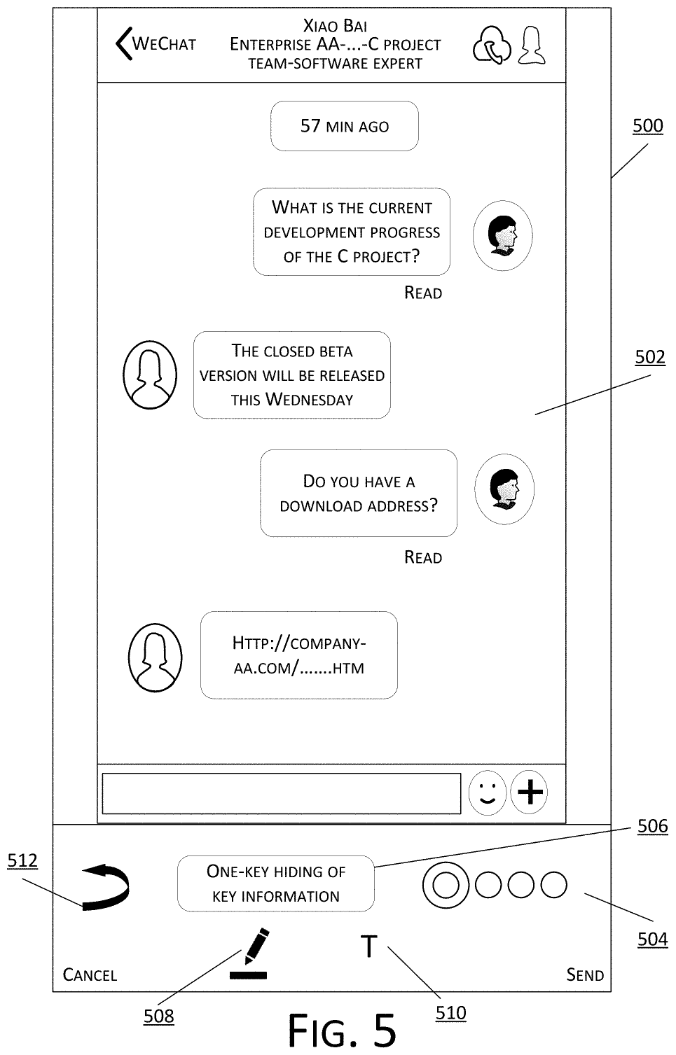

FIG. 5 is a schematic diagram of a screenshot processing interface provided in an example embodiment. In response to the foregoing triggering of the “Send” option by the user on the local side, the Instant messaging application client can be switched to a screenshot processing interface 500 as shown in FIG. 5, so that the user on the local side can perform appropriate processing of a screenshot image.

In an embodiment, a screenshot processing interface 500 may comprise a preview area 502 and an operation area 504. A user on the local side may issue editing instructions to a screenshot image through editing options contained in the operation area 504, while the preview area 502 is used to preview and display the editing effects corresponding to the editing instructions so that the user on the local side determines whether the corresponding editing instructions need to be executed or not.

In an embodiment, it is not necessary for a user on the local side to edit a screenshot image through the operation area 504. The user on the local side may directly trigger a “Send” option in a screenshot processing interface 500 to directly send the foregoing screenshot image to a user on the opposite side, “Xiao Bai.” Alternatively, the user on the local side may exit the processing and sending of a screenshot image by triggering a “Cancel” option in the screenshot processing interface 500; accordingly, the Instant messaging application client may delete the screenshot image, or automatically save the screenshot image, for future viewing, processing or sending by the user on the local side.

In an embodiment, the operation area 504 may include a button 506 for one-key hiding of key information. After detecting that the user on the local side triggers the button 506 for one-key hiding of key information, the Instant messaging application client may automatically trigger corresponding hiding processing of key information contained in a screenshot image through a technical solution of the present disclosure to hide the key information from the screenshot image.

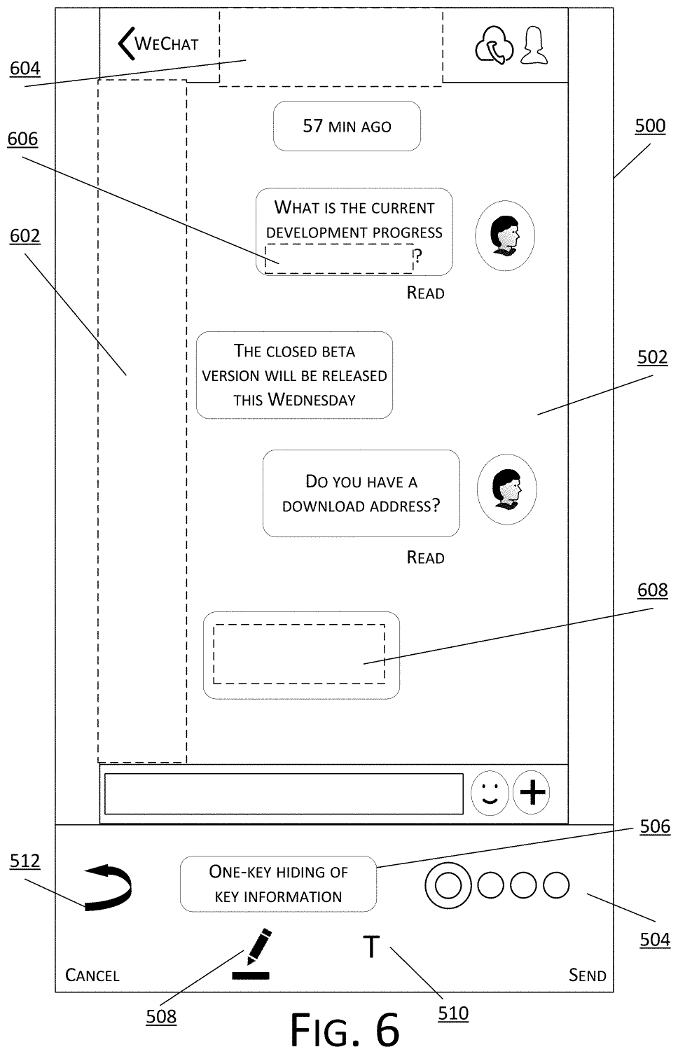

FIG. 6 is a schematic diagram of hiding of key information provided in an example embodiment. As shown in FIG. 6, when image content corresponding to an area 602, an area 604, an area 606 and an area 608 is confirmed to be key information, the image content corresponding to the areas 602 to 608 can be subjected to hiding processing. The Instant messaging application client may implement the hiding processing, and alternatively, the instant messaging application client may upload the screenshot image to an instant messaging application server and the instant messaging application server implements the hiding processing. The present disclosure has no limitation to this.

In an embodiment, by comparing the preview area 502 shown in FIG. 5 and FIG. 6, it can be known that no matter how the communication content between the user on the local side and the user on the opposite side is changed, the portrait of the user on the opposite side, “Xiao Bai,” is always located on the left edge of the communication session interface—i.e., in the foregoing area 602, while the information about the user on the opposite side, “Xiao Bai,” is always located on the top edge of the communication session interface—i.e., in the foregoing area 604. That is to say, the display areas corresponding to the display content are fixed areas and the areas 602 to 604 are only used to display the portrait and information of the user on the opposite side, “Xiao Bai,” and are not used to display other content. Therefore, when the portrait of the user on the opposite side and the name, position and other information about the user on the opposite side constitute predefined key information, the areas 602 to 604 can be directly blocked or clipped out whenever screenshot processing is conducted for the communication session interface. In this way, the corresponding key information can be hidden without having to recognizing the image content contained in the screenshot image.

In an embodiment, by comparing the preview area 502 shown in FIG. 5 and FIG. 6, it can be known that keywords “C project” corresponding to the area 606, URL “http://company-aa.com/ . . . htm” corresponding to the area 608, etc. are located in communication messages sent by the user on the local side or the user on the opposite side, while with the continuous reception and sending of communication messages, the positions of information corresponding to the areas 606 to 608 on the device screen change, too. That is to say, the display areas of the information are not fixed. Therefore, the image content contained in the screenshot image obtained in each screenshot operation needs to be recognized, for example in form of semantic recognition after character recognition based on OCR technology or in the form of recognition based on artificial intelligence algorithms. The recognition process can be completed by the Instant messaging application client or the Instant messaging application server, which is not limited by the present disclosure; assuming that the recognized key information includes the foregoing keywords “C project”, URL “http://company-aa.com/ . . . htm”, etc., the corresponding areas 606 to 608 can be blocked or clipped out. In this way, hiding processing of the corresponding key information can be completed without having to recognize the image content contained in the screenshot image.

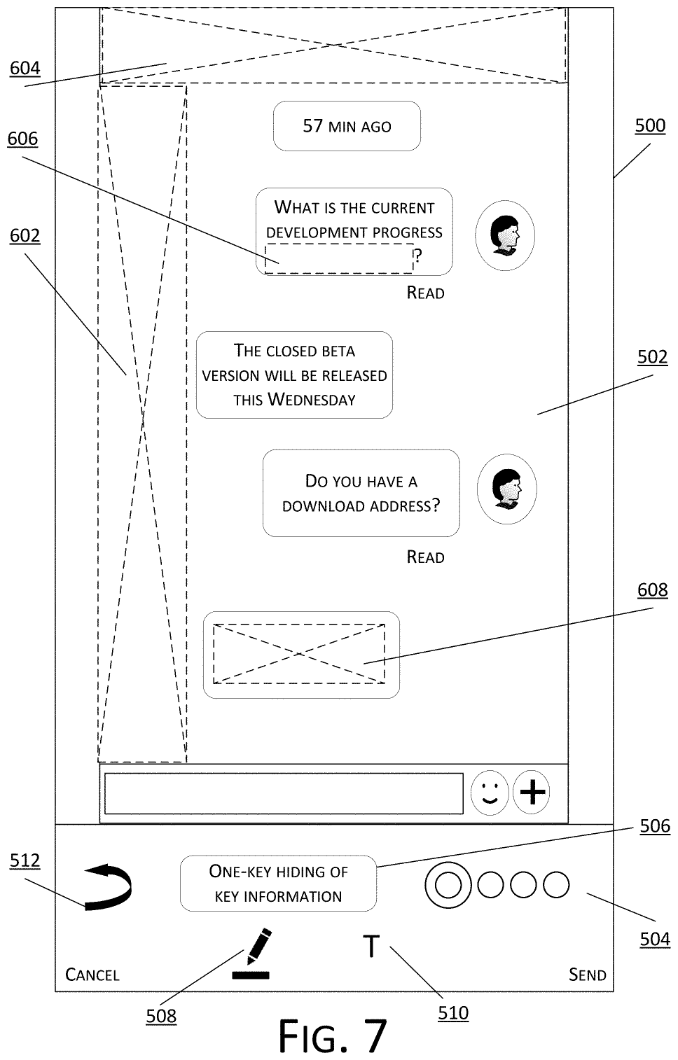

In the embodiment shown in FIG. 6, the image content corresponding to the areas 602 to 608 can be blocked to achieve hiding processing. In the embodiment shown in FIG. 7, the image content corresponding to the areas 602 to 608 can be clipped out; here, as the area 604 is located on a top edge area and the top edge area does not contain other meaningful content, the entire top edge area can be clipped out. In this way, the remaining image area is still in a rectangular shape, avoiding the remaining image area being an irregular shape.

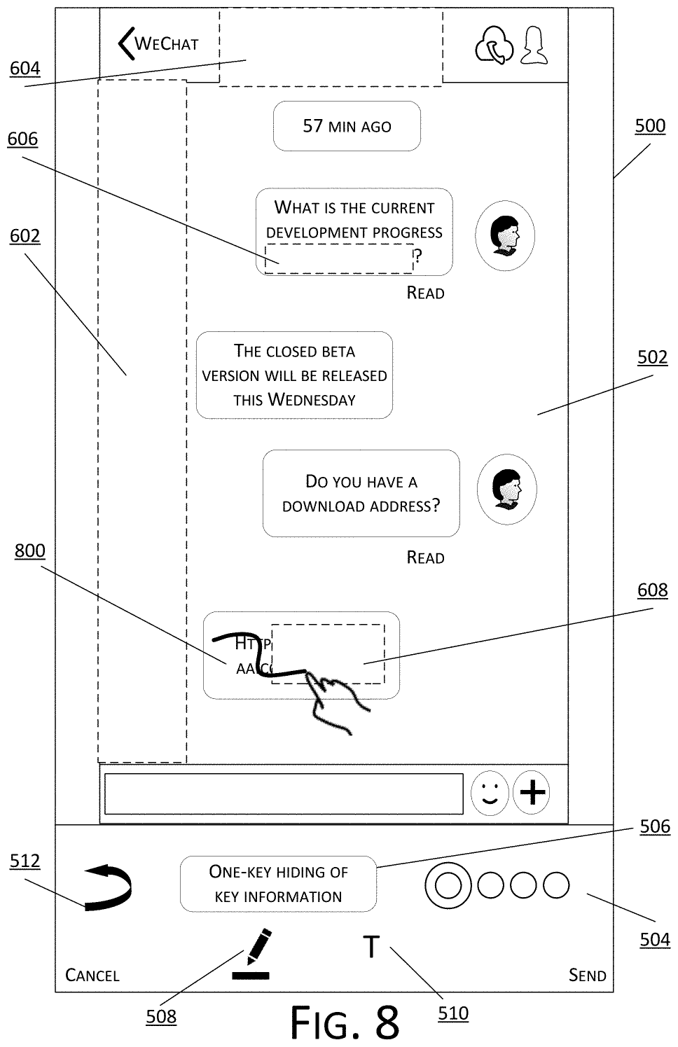

In an embodiment, a user on the local side may hope to normally display part of key content, or the user on the local side may believe that a part of non-key content is recognized as key content by mistake. For example, FIG. 8 is a schematic diagram of recovery of a normal display effect provided in an example embodiment. As shown in FIG. 8, assuming that the user on the local side hopes to normally display a URL corresponding to the area 608, the user on the local side may touch and slide in the area 608 to form a corresponding sliding locus 800, and the part of the area 608 corresponding to the sliding locus 800 may resume normal display; for example, part of URL information corresponding to the sliding locus 800 in FIG. 8 has been recovered to a state of normal display, while the user on the local side may continue to form other sliding loci rightward until all URL information is recovered to a state of normal display. The user on the local side may also recover the normal display of key information by other methods, for example by pressing and holding or forcibly pressing the display area corresponding to the key information. The present disclosure has no limitation to this. Similarly, the user on the local side may recover normal display of other key information, which is not described again here.

In an embodiment, the operation area 504 may comprise a paintbrush tool 508. When the user on the local side selects the paintbrush tool 508, a number of round options can be shown in the operation area 504. For example, these round options may be on the right of the button 506 for one-key hiding of key information and each round option represents a color of the content drawn by the paintbrush tool 508. The user on the local side may select according to the actual requirements and then can write or paint in the screenshot image through a touch and drag operation in the preview area 502, for example circle important content or add a note.

In an embodiment, the operation area 504 may comprise a text tool 510. When the user on the local side selects the text tool 510, a text box can be added in the preview area 502, characters (e.g., text, letter, number or punctuation), patterns, etc. are input in the text box, the color, font, transparency, etc. of the input characters can be adjusted and further, the specification of the text box can be adjusted, too.

In an embodiment, the operation area 504 may comprise a withdrawal option 512. After the user on the local side implements any operation using the paintbrush tool 508 or the text tool 510, etc., the withdrawal option 512 may be used to withdraw the implementation to provide a chance of an undo option.

In an embodiment, after the user on the local side determines that processing of a screenshot image is completed, the screenshot image can be sent to the user on the opposite side, “Xiao Bai,” or to other users by clicking on a Send option; or, the user on the local side may choose not to send the screenshot image at once, but click on the cancellation option to exit the screenshot processing interface 500, while the Instant messaging application client can automatically save the initial screenshot image (the key content is not hidden and no other operations are implemented through the operation area 504) and the processed screenshot image for viewing by the user on the local side, or to send them to any user in the future.

In an embodiment, although the mobile phone 106 is taken as an example in FIG. 3 to FIG. 8 for description, a screenshot processing solution of the present disclosure can be applied to any type of electronic device, which is not limited by the present disclosure. For example, when the screenshot processing solution of the present disclosure is implemented in a PC, the implementation process is substantially similar to the foregoing embodiment implemented in the mobile phone 106, but in some steps, there are some changes relevant to the features of the devices. For example, when a user on the local side implements a screenshot operation in a PC, the user on the local side can use the shortcut keys on the keyboard or use the mouse to click on the “Screenshot” function button in the communication session interface to trigger a screenshot function. Here, when a screenshot operation is implemented, in one case, all the display content on the PC display can be captured; in another case, only the display content corresponding to the Instant messaging application client on the PC display can be captured; and in a further case, the user may manually select the display content that needs to be captured.

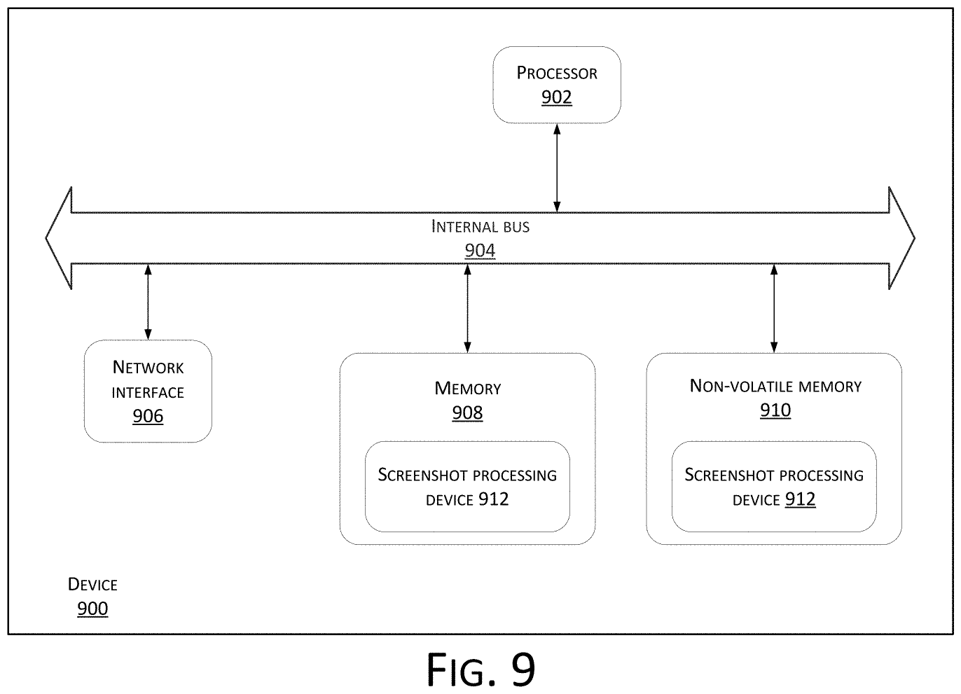

FIG. 9 is a structural schematic diagram of a device 900 provided in an example embodiment. Please refer to FIG. 9. At the hardware level, the device 900 comprises a processor 902, an internal bus 904, a network interface 906, a memory 908 and a non-volatile memory 910; certainly, the device 900 may also comprise hardware needed by other services. The processor 902 reads a corresponding computer program from the non-volatile memory 910 to the memory 908 and forms a screenshot processing unit 912 at a logical level. Certainly, in addition to the implementation via software, one or more embodiments of the present disclosure do not exclude other manners of implementation, such as a logical device or a combination of hardware and software. In other words, the implementers of the following processing flow are not limited to logical units and can be hardware or logical devices as well.

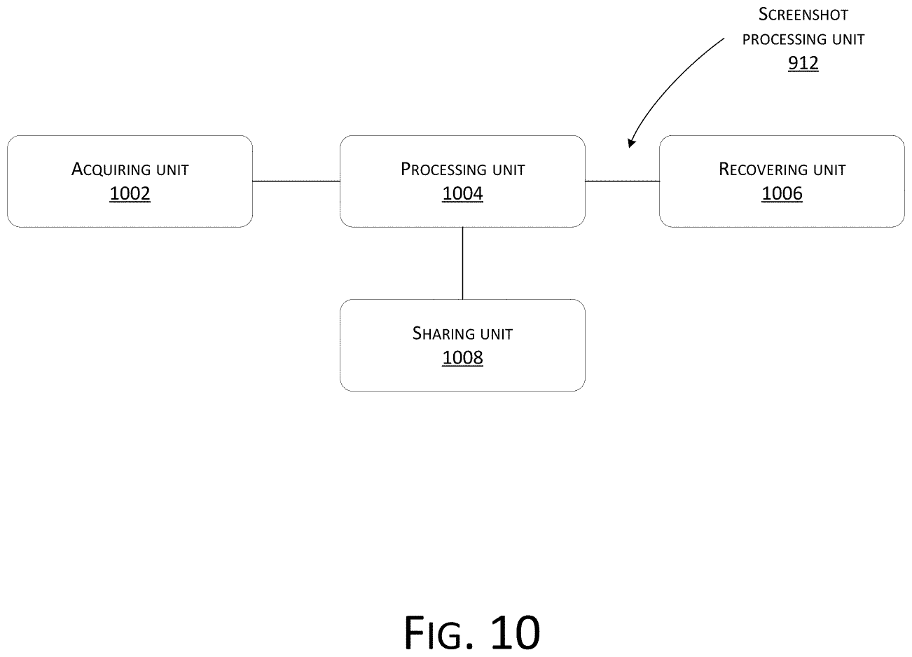

Please refer to FIG. 10, for example, the screenshot processing unit 912 may comprise:

an acquiring unit 1002, for acquiring a screenshot image; and

a processing unit 1004, for hiding private content contained in the screenshot image.

For example, the processing unit 1004 is specifically used to:

perform hiding processing of the image content in the preset fixed area when the private content is in the preset fixed area of the screenshot image.

For example, the processing unit 1004 is specifically used to:

recognize private content contained in the screenshot image; and

hide the recognized private content.

For example, the processing unit 1004 is specifically used to:

block the private content; or

clip out an image area corresponding to the private content.

For example, the processing unit 1004 is specifically used to:

hide the private content locally; or

upload the screenshot image to a server so that the server hides the private content.

For example, the private content includes at least one of:

preset types of information and information containing preset content.

For example, the device 900 is applied to a client device for instant messaging application;

the acquiring unit 1002 is specifically used to implement a screenshot operation for an application interface of the instant messaging application to obtain the screenshot image;

the processing unit 1004 is specifically used to show an option for enabling a private content hiding function provided by the instant messaging application regarding the screenshot image, and hide the private content contained in the screenshot image when the enabling option is triggered.

For example, the acquiring unit 1002 is specifically used to implement a screenshot operation for the screen display content of a device on the local side to obtain the screenshot image.

The processing unit 1004 is specifically used to show an option for enabling a private content hiding function provided by the operating system of the device on the local side regarding the screenshot image, and hide the private content contained in the screenshot image when the enabling option is triggered.

For example, the screenshot processing unit 912 also comprises:

the recovering unit 1006, for recovering normal display of at least one piece of private content in response to a recovery operation of the at least one piece of private content hidden during the hiding processing.

For example, the screenshot processing unit 912 also comprises:

a sharing unit 1008, for sharing the processed screenshot image.

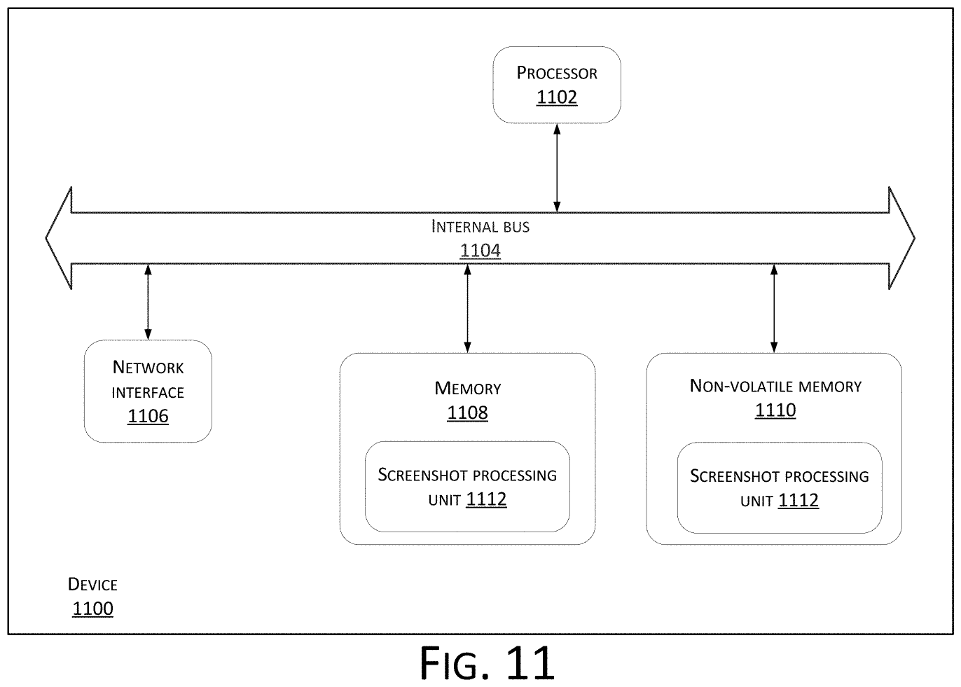

FIG. 11 is a structural schematic diagram of a device 1100 provided in an example embodiment. Please refer to FIG. 11. At the hardware level, the device 1100 comprises a processor 1102, an internal bus 1104, a network interface 1106, a memory 1108 and a non-volatile memory 1110; the device 1100 certainly may also comprise hardware needed by other services. The processor 1102 reads a corresponding computer program from the non-volatile memory 1110 to the memory 1108 and then runs the computer program to form a screenshot processing unit 1112 at a logical level. Certainly, in addition to the implementation via software, one or more embodiments of the present disclosure do not exclude other manners of implementation, such as a logical device or a combination of hardware and software. In other words, the implementers of the following processing flow are not limited to logical units and can be hardware or logical devices as well.

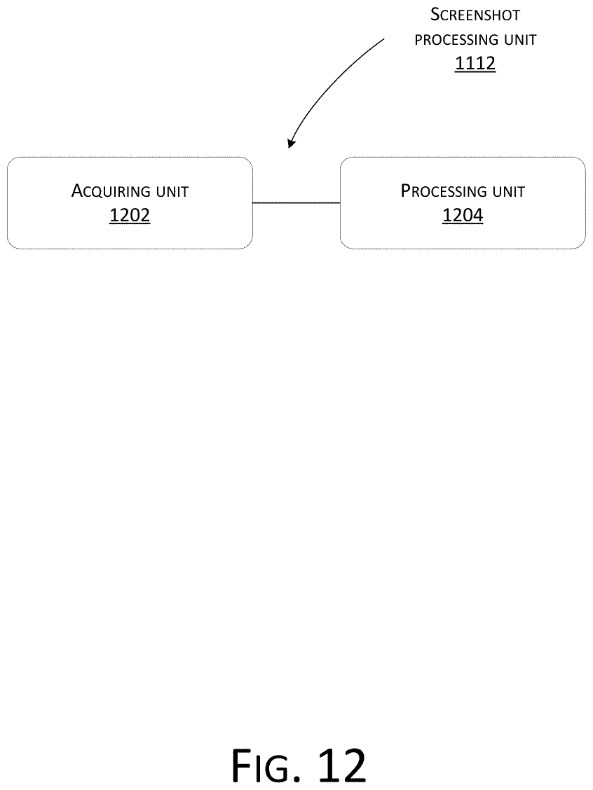

Referring to FIG. 12, the screenshot processing unit 1112 may comprise:

an acquiring unit 1202, for acquiring a screenshot image;

a processing unit 1204, for processing at least a part of the content contained in the screenshot image, so that the at least a part of the content is invisible in the processed screenshot image.

For example, at least a part of the content includes private content.

For example, at least a part of the content includes at least one of:

content located in the preset fixed area of the screenshot image and content containing preset types of information.

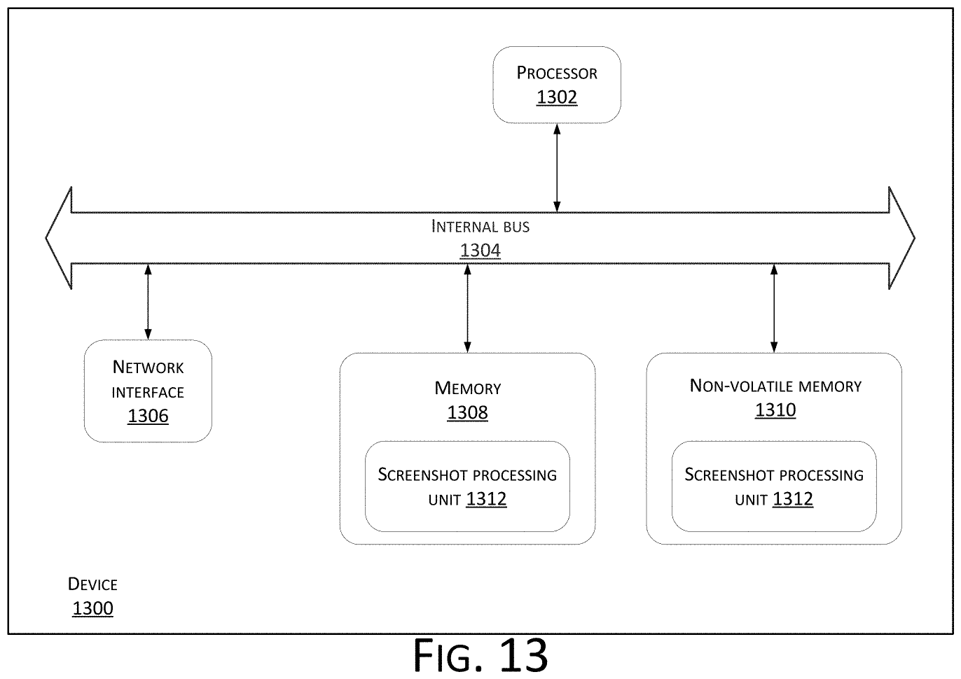

FIG. 13 is a structural schematic diagram of a device 1300 provided in an example embodiment. Please refer to FIG. 13. At the hardware level, the device 1300 comprises a processor 1302, an internal bus 1304, a network interface 1306, a memory 1308 and a non-volatile memory 1310; the device 1300 certainly may also comprise hardware needed by other services. The processor 1302 reads a corresponding computer program from the non-volatile memory 1310 to the memory 1308 and then runs the computer program to form a screenshot processing unit 1312 at a logical level. Certainly, in addition to the implementation via software, one or more embodiments of the present disclosure do not exclude other manners of implementation, such as a logical device or a combination of hardware and software. In other words, the implementers of the following processing flow are not limited to logical units and can be hardware or logical devices, too.

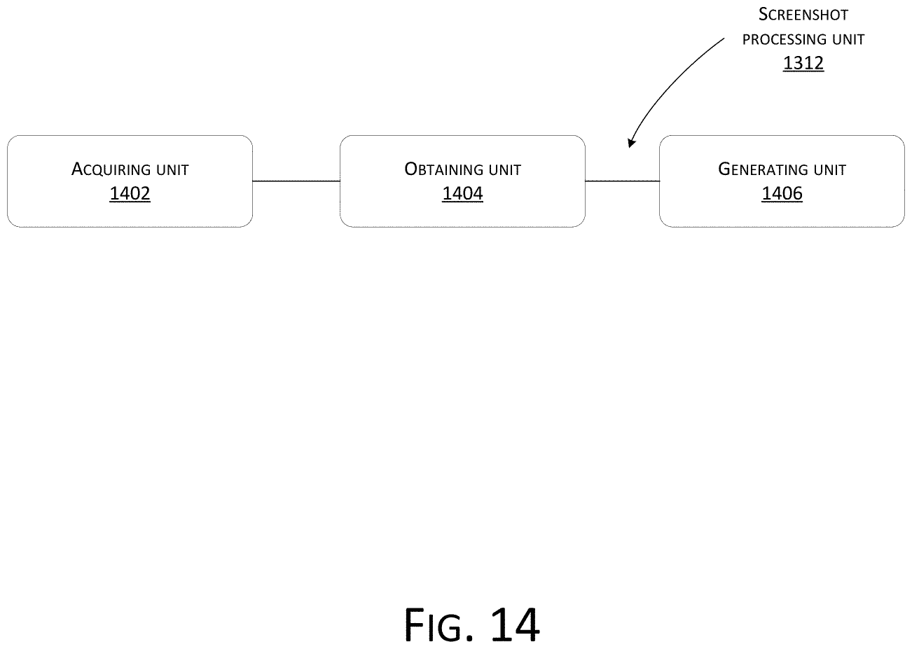

Please refer to FIG. 14. In an implementation via software, the screenshot processing device can comprise:

an acquiring unit 1402, for acquiring a screenshot image according to a screenshot operation implemented by a user;

an obtaining unit 1404, for obtaining a screenshot image after hiding processing according to a trigger operation implemented by the user to a one-key hide button corresponding to the screenshot image, wherein at least a part of the content in the screenshot image is subjected to the hiding processing; and

a generating unit 1406, generating a final image according to the screenshot image obtained after the hiding processing.

For example, the generating unit 1406 is specifically used to:

use the screenshot images after the hiding processing as the final images; or

generate the final images according to the editing operation implemented by the user on the screenshot image after the hiding processing.

The systems, devices, modules or units illustrated in the foregoing embodiment specifically can be implemented using computer chips or entities or implemented using a product with certain functions. A typical implementation device is a computer. A specific form of the computer can be a personal computer, a laptop computer, a cellular phone, a camera phone, a smart phone, a personal digital assistant, a media player, a navigation device, an email receiving and sending device, a game console, a tablet computer, a wearable device, or a combination of any of these devices.

In a typical configuration, a computer device comprises one or a plurality of processing units (CPUs), input/output interfaces, network interfaces, and memory.

A memory may include a volatile storage device on a computer-readable medium, a random-access memory (RAM), and/or a non-volatile memory, such as a read-only memory (ROM), or a flash memory (flash RAM). A memory is an example of the computer-readable medium.

Computer-readable media include both permanent and non-permanent, removable and non-removable media, and may store information by any method or technology. The information may be a computer readable instruction, a data structure, a module of a program, or other data. Examples of computer storage media include, but are not limited to, a phase change memory (PRAM), a static random access memory (SRAM), a dynamic random access memory (DRAM), other types of random access memories (RAMs), a read only memory (ROM), an electrically erasable programmable read-only memory (EEPROM), a flash memory or other memory technologies, a compact disk read-only memory (CD-ROM), a digital versatile disc (DVD) or other optical storage devices, a cassette-type magnetic tape, a magnetic disk storage, a quantum memory, a graphene-based storage medium or other magnetic storage devices or any other non-transmission medium, and may be used for storing information accessible by computing devices. As defined herein, the computer-readable media do not include transitory media, such as modulated data signals and carriers.

It should be further noted that terms “comprise,” “include” and any other equivalent expressions are intended to cover non-exclusive inclusion so that a process, method, commodity or device comprising a series of factors not only includes these factors but also includes other factors not expressly listed, or also includes factors inherent to the process, method, commodity or device. Under the condition of no further limitation, the factors delimited by expression “comprise a . . . ” do not exclude other same factors in the process, method, commodity or device including said factors.

Specific embodiments of the present disclosure have been described above. Other embodiments are within the scope of the appended claims. In some cases, the actions or steps stated in the claims can be performed in a different order from the orders shown in the embodiments and still achieve the desired results. In addition, the processes depicted in the drawings do not necessarily require the shown specific order or sequential order to achieve the desired results. In some manners of implementation, multitasking and parallel processing are also possible or may be advantageous.

Terms used in one or more embodiments of the present disclosure are for the purpose of describing specific example embodiments only and are not intended to limit one or more embodiments of the present disclosure. Unless otherwise noted in the context, the singular forms “a,” “an,” “the” and “said” used in one or more embodiments of the present disclosure and appended claims are also intended to represent plural forms thereof. It should also be understood that the term “and/or” used herein refers to any or all possible combinations including one or more associated and listed items.

Although the terms first, second, third, etc. may be used to describe various information in one or more embodiments of the present disclosure, the information should not be limited to these terms. These terms are only used to differentiate the same type of information. For example, without departing from the scope of one or more embodiments of the present disclosure, the first information can also be called the second information, and similarly, the second information can also be called the first information. Depending on the context, the term “if” as used herein may be interpreted as “when,” or “in the case that,” or “in response to a determination.”

The foregoing one or more embodiments of the present disclosures are preferred embodiments and are not intended to limit the one or more embodiments of the present disclosure. All modifications, identical replacements and improvements made without departing from the spirit and principle of the one or more embodiments of the present disclosure shall be within the protection scope of the one or more embodiments of the present disclosure.

The present disclosure may further be understood with clauses as follows.

Clause 1. A screenshot processing method, wherein the screenshot processing method comprises:

acquiring a screenshot image; and

hiding private content contained in the screenshot image.

Clause 2. The method according to clause 1, wherein the hiding private content contained in the screenshot image comprises:

performing hiding processing of image content in a preset fixed area when the private content is located in the preset fixed area of the screenshot image.

Clause 3. The method according to clause 1, wherein the hiding private content contained in the screenshot image comprises:

recognizing private content contained in the screenshot image; and

hiding the recognized private content.

Clause 4. The method according to clause 1, wherein the hiding private content contained in the screenshot image comprises:

blocking the private content; or

clipping out an image area corresponding to the private content.

Clause 5. The method according to clause 1, wherein the hiding private content contained in the screenshot image comprises:

hiding the private content locally; or

uploading the screenshot image to a server so that the server hides the private content.

Clause 6. The method according to clause 1, wherein the private content includes at least one of:

preset types of information and information containing preset content.

Clause 7. The method according to clause 1, wherein the device is applied to a client device for instant messaging application;

the acquiring a screenshot image comprises implementing a screenshot operation for an application interface of the instant messaging application to obtain the screenshot image; and

the hiding private content contained in the screenshot image comprises showing an option for enabling a private content hiding function provided by the instant messaging application regarding the screenshot image, and hiding the private content contained in the screenshot image when the enabling option is triggered.

Clause 8. The method according to clause 1, wherein

the acquiring a screenshot image comprises implementing a screenshot operation for the screen display content of a device on the local side to obtain the screenshot image; and

the hiding private content contained in the screenshot image comprises showing an option for enabling a private content hiding function provided by the operating system of the device on the local side regarding the screenshot image, and hiding the private content contained in the screenshot image when the enabling option is triggered.

Clause 9. The method according to clause 1, wherein the method further comprises:

recovering normal display of at least one piece of private content in response to a recovery operation of the at least one piece of private content hidden during the hiding processing.

Clause 10. The method according to clause 1, wherein the method further comprises:

sharing the processed screenshot image.

Clause 11. A screenshot processing device, wherein the screenshot processing device comprises:

an acquiring unit, for acquiring a screenshot image; and

a processing unit, for hiding private content contained in the screenshot image.

Clause 12. The device according to clause 11, wherein the processing unit is specifically used to:

perform hiding processing of the image content in a preset fixed area when the private content is located in the preset fixed area of the screenshot image.

Clause 13. The device according to clause 11, wherein the processing unit is specifically used to:

recognize private content contained in the screenshot image; and

hide the recognized private content.

Clause 14. The device according to clause 11, wherein the processing unit is specifically used to:

block the private content; or

clip out an image area corresponding to the private content.

Clause 15. The device according to clause 11, wherein the processing unit is specifically used to:

hide the private content locally; or

upload the screenshot image to a server so that the server hides the private content.

Clause 16. The device according to clause 11, wherein the private content includes at least one of:

preset types of information and information containing preset content.

Clause 17. The device according to clause 11, wherein the device is applied to a client device for instant messaging application;

the acquiring unit is specifically used to implement a screenshot operation for an application interface of the instant messaging application to obtain the screenshot image;

the processing unit is specifically used to show an option for enabling a private content hiding function provided by the instant messaging application regarding the screenshot image, and hide the private content contained in the screenshot image when the enabling option is triggered.

Clause 18. The device according to clause 11, wherein

the acquiring unit is specifically used to implement a screenshot operation for the screen display content of a device on the local side to obtain the screenshot image; and

the processing unit is specifically used to show an option for enabling a piece of private content hiding function provided by the operating system of the device on the local side regarding the screenshot image; and hide the private content contained in the screenshot image when the enabling option is triggered.

Clause 19. The device according to clause 11, wherein the device further comprises:

a recovering unit, for recovering normal display of at least one piece of private content in response to a recovery operation of the at least one piece of private content hidden during the hiding processing.

Clause 20. The device according to clause 11, wherein the device further comprises:

a sharing unit, for sharing the processed screenshot image.

Clause 21. A screenshot processing method, wherein the screenshot processing method comprises:

acquiring a screenshot image; and

processing at least a part of the content contained in the screenshot image, so that the at least a part of the content is invisible in the processed screenshot image.

Clause 22. The method according to clause 21, wherein at least a part of the content includes private content.

Clause 23. The method according to clause 21, wherein at least a part of the content includes at least one of:

content located in the preset fixed area of the screenshot image and content containing preset types of information.

Clause 24. A screenshot processing method, wherein the screenshot processing method comprises:

acquiring a screenshot image according to a screenshot operation implemented by a user;

obtaining a screenshot image after hiding processing according to a trigger operation implemented by the user to a one-key hide button corresponding to the screenshot image, wherein at least a part of the content in the screenshot image is subjected to the hiding processing; and

generating a final image according to the screenshot image obtained after the hiding processing.

Clause 25. The method according to clause 24, wherein the generating a final image according to the screenshot image obtained after the hiding processing comprises:

using the screenshot images after the hiding processing as the final images; or

generating the final images according to the editing operation implemented by the user on the screenshot image after the hiding processing.

Clause 26. A screenshot processing device, wherein the screenshot processing device comprises:

an acquiring unit, for acquiring a screenshot image; and
a processing unit, for processing at least a part of the content contained in the screenshot image, so that the at least a part of the content is invisible in the processed screenshot image.

Clause 27. The device according to clause 26, wherein at least a part of the content includes private content.

Clause 28. The device according to clause 26, wherein at least a part of the content includes at least one of:

content located in the preset fixed area of the screenshot image and content containing preset types of information.

Clause 29. A screenshot processing device, wherein the screenshot processing device comprises:

an acquiring unit, for acquiring a screenshot image according to a screenshot operation implemented by a user;

an obtaining unit, for obtaining a screenshot image after hiding processing according to a trigger operation implemented by the user to a one-key hide button corresponding to the screenshot image, wherein at least a part of the content in the screenshot image is subjected to the hiding processing; and

a generating unit, for generating a final image according to the screenshot image obtained after the hiding processing.

Clause 30. The device according to clause 29, wherein the generating unit is specifically used to:

use the screenshot images after the hiding processing as the final images; or

generate the final images according to the editing operation implemented by the user on the screenshot image after the hiding processing.

What is claimed is:

1. A method comprising:
acquiring a screenshot image; and
hiding a private content contained in the screenshot image.

2. The method according to claim 1, wherein the hiding the private content contained in the screenshot image comprises:
determining that an image content is located in a preset fixed area of the screenshot image; and
performing a hiding processing of the image content in the preset fixed area.

3. The method according to claim 1, wherein the hiding the private content contained in the screenshot image comprises:
identifying the private content contained in the screenshot image; and
hiding the private content.

4. The method according to claim 1, wherein the hiding the private content contained in the screenshot image comprises:
blocking the private content.

5. The method according to claim 1, wherein the hiding the private content contained in the screenshot image comprises:
clipping out an image area corresponding to the private content.

6. The method according to claim 1, wherein the hiding the private content contained in the screenshot image comprises:
performing a hiding processing of the private content locally.

7. The method according to claim 1, wherein the hiding the private content contained in the screenshot image comprises:
uploading the screenshot image to a server to hides the private content.

8. The method according to claim 1, wherein the private content includes a preset type of information.

9. The method according to claim 1, wherein the private content includes information containing a preset content.

10. The method according to claim 1, further comprising:
recovering the private content hidden during the hiding processing; and
displaying the recovered private content.

11. The method according to claim 1, further comprising:
sharing the screenshot image after hiding the private content.

12. A device comprising:
one or more processors; and
one or more computer-readable media storing thereon computer-readable instructions that, when executed by the one or more processors, cause the one or more processors to perform acts comprising:
acquiring a screenshot image; and
hiding a private content contained in the screenshot image.

13. The device according to claim 12, wherein the hiding the private content contained in the screenshot image comprises:
determining that an image content is located in a preset fixed area of the screenshot image; and
performing a hiding processing of the image content in the preset fixed area.

14. The device according to claim 12, wherein the hiding the private content contained in the screenshot image comprises:
identifying the private content contained in the screenshot image; and
hiding the private content.

15. The device according to claim 12, wherein the hiding the private content contained in the screenshot image comprises:
blocking the private content; or
clipping out an image area corresponding to the private content.

16. The device according to claim 12, wherein the hiding the private content contained in the screenshot image comprises:
performing a hiding processing of the private content locally; or
uploading the screenshot image to a server to hides the private content.

17. The device according to claim 12, wherein the private content includes at least one of:
a preset type of information; and
information containing a preset content.

18. The device according to claim 1, wherein the acts further comprise:
recovering the private content hidden during the hiding processing; and
displaying the recovered private content.

19. One or more computer-readable media storing thereon computer-readable instructions that, when executed by one or more processors, cause the one or more processors to perform acts comprising:
acquiring a screenshot image; and
hiding a private content contained in the screenshot image.

20. The one or more computer-readable media according to claim 19, wherein the hiding the private content contained in the screenshot image comprises:
determining that an image content is located in a preset fixed area of the screenshot image; and
performing a hiding processing of the image content in the preset fixed area.
